(19) United States
(12) Patent Application Publication
(10) Pub. No.: US 2008/0222700 A1
(43) Pub. Date: Sep. 11, 2008

(54) Challenge/Response in a Multiple Operating System Environment

(76) Inventors: Itzhack Goldberg, Hadera (IL); Ilan Shimony, Haifa (IL)

Correspondence Address: Stephen C. Kaufman;IBM CORPORATION, Intellectual Property Law Dept., P.O. Box 218, Yorktown Heights, NY, 10598, US

(21) Appl. No.: 11/682,895

(22) Filed: Mar. 7, 2007

(51) Int. Cl. H04L 9/00

(52) U.S. Cl. 726/3

(57) ABSTRACT

a secure challenge-response virtualization system including a computer having a memory divided into at least a first and a second logical partition, where the first partition is operative to receive a challenge from an entity, and a challenge/response manager configured with the second partition, where the first partition is configured to provide the challenge to the challenge/response manager configured with the second partition, and where the challenge/response manager is configured to generate a response to the challenge and provide the response to the first partition.

### FIELD OF THE INVENTION

The present invention relates to challenge/response systems in general, and more particularly to providing a secure challenge/response system on a single computer running multiple operating systems.

### BACKGROUND OF THE INVENTION

The success of web based systems in many cases today is dependent on accurate and reliable user authentication. The readiness of users to retrieve or submit proprietary information over the web is negatively correlated to the risk of an adversary accessing that information.

Typically users will exchange one or more encrypted passwords with the system they are trying to log into. However, passwords must be relatively short to allow for memorization and thus can be guessed by an adversary, or they can be stolen using a key logger or other kinds of Trojan Horse software. Additionally, many algorithms used to create encrypted passwords can be deciphered on relatively standard computers in order to learn the identity of the encrypted password. One solution is to use a biometric device to identify the user. Aside from concerns with identity theft and privacy issues, here too, an adversary or virus could gain low level access, say at the BIOS level, and copy the biometric data.

Smart cards solve these problems using challenge-response protocols, by sending a valid response to every challenge. The response is typically a cryptographic function of, among other things, the challenge, the date and time, and the user password. However, smart card systems add to the cost of challenge/response systems and the smart cards themselves can be lost or stolen. Such systems also have other limitations in that they are often difficult to manage, involving distribution and maintenance of equipment as well as firmware updates, and usually require clock synchronization with the remote system.

### SUMMARY OF THE INVENTION

The present invention in embodiments thereof discloses systems and methods for providing a secure challenge/response system on a single computer running multiple operating systems.

In one aspect of the present invention a secure challenge-response virtualization system is provided including a computer having a memory divided into at least a first and a second logical partition, where the first partition is operative to receive a challenge from an entity, and a challenge/response manager configured with the second partition, where the first partition is configured to provide the challenge to the challenge/response manager configured with the second partition, and where the challenge/response manager is configured to generate a response to the challenge and provide the response to the first partition.

In another aspect of the present invention a method is provided for providing challenge-response transactions in a virtualization system, the method including receiving a challenge at a first logical partition of a memory of a computer, providing the challenge to a second partition of the memory of the computer, generating at the second partition a response to the challenge, and providing the response to the first partition.

In another aspect of the present invention a method is provided for providing challenge-response transactions in a virtualization system, the method including configuring a first logical partition of a memory of a computer to provide to a second partition a challenge received by the first partition, and configuring the second partition to generate a response to the challenge and provide the response to the first partition.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a secure challenge-response virtualization system, constructed and operative in accordance with an embodiment of the present invention;

FIG. 2 is a simplified block-flow illustration of an exemplary operational scenario of the system of FIG. 1, operative in accordance with a preferred embodiment of the present invention; and

FIG. 3 is a simplified flowchart illustration of an exemplary method of operation of the system of FIG. 1, operative in accordance with a preferred embodiment of the present invention.

### DETAILED DESCRIPTION OF THE INVENTION

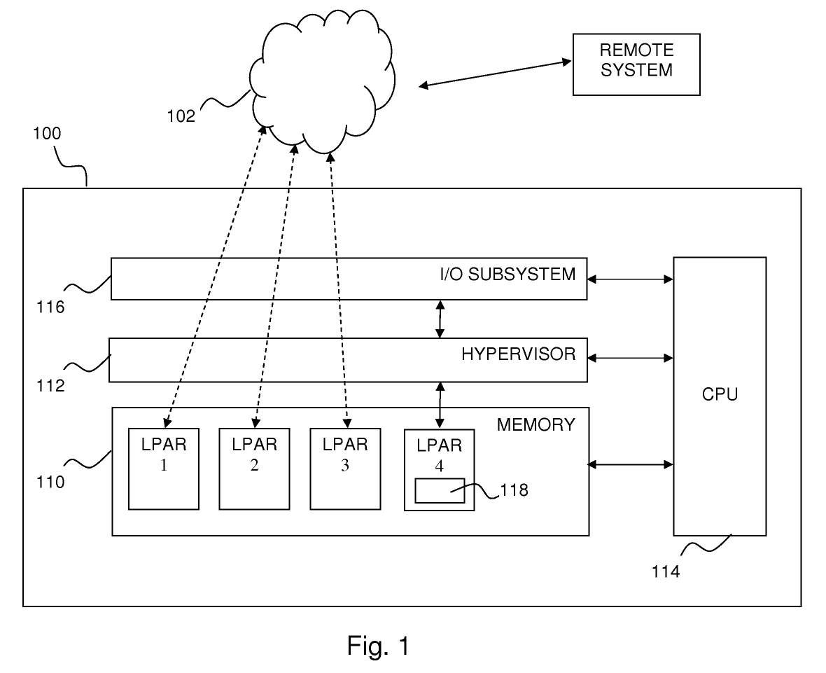

Reference is now made to FIG. 1, which is a simplified conceptual illustration of a secure challenge-response virtualization system, constructed and operative in accordance with a preferred embodiment of the present invention. In the system of FIG. 1 a computer 100 is provided with a CPU 114, a memory 110, and an input/output (I/O) subsystem 116, such as for facilitating communication with elements outside the computer such as a network 102. Memory 110 of computer 100 is preferably divided into several logical partitions, such as partitions LPAR 1-LPAR 4. At least one of the partitions, such as LPAR 4, includes a challenge/response manager 118 and is preferably dedicated to the operation of challenge/response manager 118, while the other partitions may, for example, each run a different operating system. LPAR 4 is preferably a “secure” partition in that it is configured such that it cannot directly communicate with elements outside of computer 100. A hypervisor 112 is provided through which the partitions may communicate with each other and, additionally, via I/O subsystem 116, with elements outside of computer 100, such as with other computers via a network 102, such as the Internet.

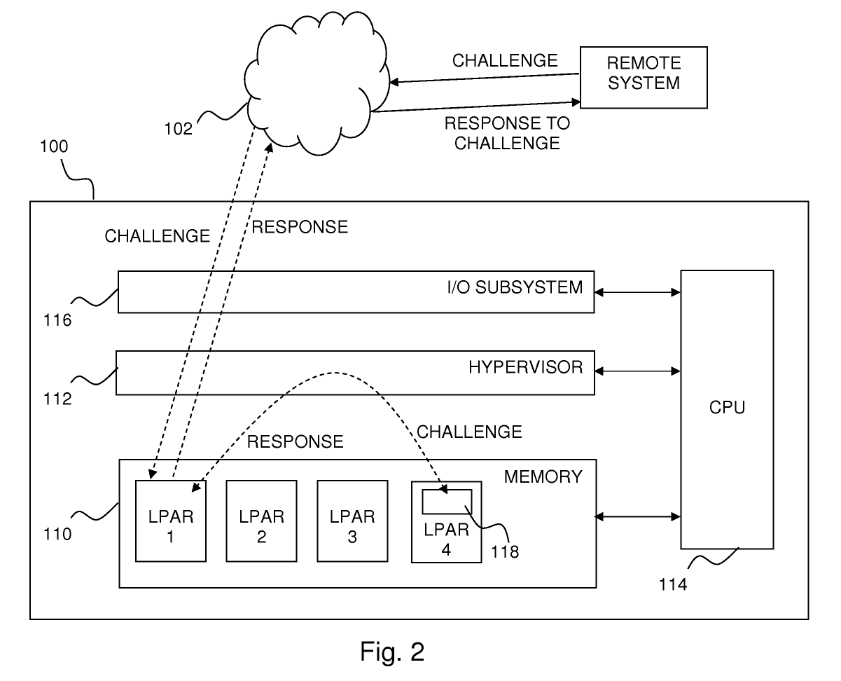

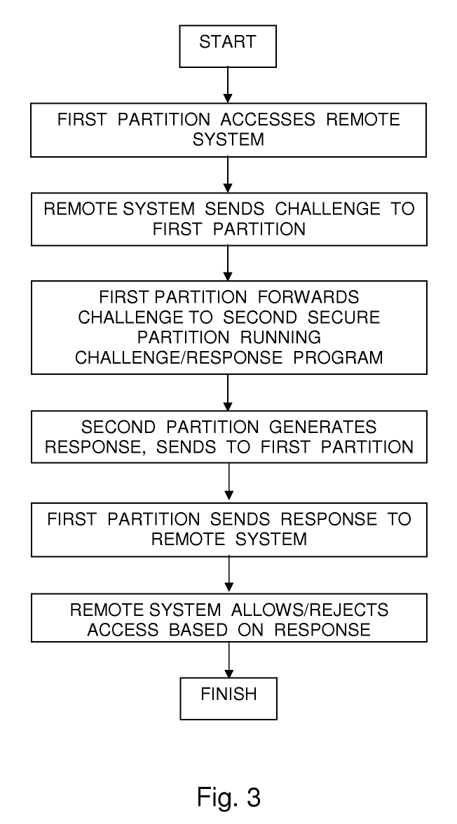

Reference is now made to FIG. 2, which is a simplified block-flow illustration of an exemplary operational scenario of the system of FIG. 1, operative in accordance with a preferred embodiment of the present invention, and additionally to FIG. 3, which is a simplified flowchart illustration of an exemplary method of operation of the system of FIG. 1, operative in accordance with a preferred embodiment of the present invention. In the scenario of FIG. 2 a user operates a browser program in LPAR 1 and accesses a remote system via network 102, such as to access the user's bank account. The remote system sends LPAR 1 a challenge using conventional techniques and awaits a valid response. After receiving the challenge LPAR 1 then provides the challenge via hypervisor 112 to challenge/response manager 118 running on partition LPAR 4 which then generates the appropriate response. LPAR 4 then provides the response to LPAR 1 via hypervisor 112. Communications between LPAR 1 and LPAR 4 may be facilitated using shared memory, which may be secured using conventional techniques. LPAR 1 may then display the response to the user who then inputs the response into a form provided by the remote system, or LPAR 1 may itself send the response to the remote system via network 102 for authentication, whereupon the remote system may allow/reject access based on validity of the response.

It will be appreciated that challenge and/or response may be communicated to/from the various partitions using means other that a hypervisor. For example, the partitions may use a shared memory and/or shared hardware registers into which the challenge and/or response may be written and from which may be read. Alternatively, the challenge and/or response need not be transmitted automatically between the partitions. Rather, the user may receive and note the challenge in LPAR 1, switch his view to LPAR 4, manually enter the challenge in LPAR 4, receive and note the response, switch his view back to LPAR 1, and manually enter the response in LPAR 1.

It will be appreciated that by placing the challenge/response manager within a partition that is only indirectly accessible to challengers, and that is separate from other partitions that themselves access those secure systems that issue challenges, the present invention offers a greater degree of security against hacking attempts.

While the methods and apparatus herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A secure challenge-response virtualization system comprising:
a computer having a memory divided into at least a first and a second logical partition, wherein said first partition is operative to receive a challenge from an entity; and
a challenge/response manager configured with said second partition,
wherein said first partition is configured to provide said challenge to said challenge/response manager configured with said second partition, and
wherein said challenge/response manager is configured to generate a response to said challenge and provide said response to said first partition.

2. A system according to claim 1 wherein said first partition is configured to provide said response to said entity in response to said challenge.

3. A system according to claim 1 wherein said entity is outside of said computer

4. A system according to claim 1 and further comprising a hypervisor configured to facilitate communications between said partitions.

5. A system according to claim 1 wherein said second partition is dedicated to the operation of said challenge/response manager.

6. A system according to claim 1 wherein said second partition is isolated from receiving communications from said entity.

7. A method for providing challenge-response transactions in a virtualization system, the method comprising:
receiving a challenge at a first logical partition of a memory of a computer;
providing said challenge to a second partition of said memory of said computer;
generating at said second partition a response to said challenge; and
providing said response to said first partition.

8. A method according to claim 7 and further comprising providing said response to an entity in response to said challenge issued by said entity.

9. A method according to claim 7 wherein any of said providing steps comprises providing via a hypervisor.

10. A method according to claim 7 and further comprising isolating said second partition from receiving said challenge directly from an entity that issues said challenge.

11. A method according to claim 7 and further comprising configuring said second partition to perform said generating step dedicatedly.

12. A method for providing challenge-response transactions in a virtualization system, the method comprising:
configuring a first logical partition of a memory of a computer to provide to a second partition a challenge received by said first partition; and
configuring said second partition to generate a response to said challenge and provide said response to said first partition.

13. A method according to claim 12 and further comprising providing said response to an entity in response to said challenge issued by said entity.

14. A method according to claim 12 wherein any of said configuring steps comprises configuring said partitions to communicate with each other via a hypervisor.

15. A method according to claim 12 and further comprising configuring said second partition to perform said generating step dedicatedly.

16. A method according to claim 12 and further comprising isolating said second partition from receiving said challenge directly from an entity that issues said challenge.
